(19) United States
(12) Patent Application Publication
(10) Pub. No.: US 2009/0093909 A1
(43) Pub. Date: Apr. 9, 2009

(54) CONTROL SYSTEM AND A METHOD FOR CONTROLLING A REFRIGERATION SYSTEM COMPRISING TWO OR MORE COMPRESSORS

(75) Inventors: Kristoffer Riemann Hansen, Broager (DK); Anders Jakob Madsen, Nordborg (DK); Rune Thomsen, Loegumkloster (DK)

Correspondence Address: MCCORMICK, PAULDING & HUBER LLP, CITY PLACE II, 185 ASYLUM STREET, HARTFORD, CT, 06103, US

(73) Assignee: DANFOSS COMPRESSORS GMBH, Flensburg (DE)

(21) Appl. No.: 12/065,671

(22) PCT Filed: Aug. 30, 2006
(86) PCT No.: PCT/DK06/00465

§ 371 Date: Oct. 27, 2008

(30) Foreign Application Priority Data
Sep. 6, 2005 (DK) PA 2005 01244

(51) Int. Cl. G05B 15/00; F25B 7/00

(52) U.S. Cl. 700/275; 62/335

(57) ABSTRACT

A control system (12) for controlling a refrigeration system (17) comprising two or more compressors (13a, 13b) (e.g. a twin compressor system). Each compressor (13a, 13b) is connected to an electronic unit (14a, 14b), and the electronic units (14a, 14b) are adapted to communicate appropriate signals to each other when the corresponding compressor (13a, 13b) starts or stops operation. The electronics units (14a, 14b) are further adapted to control the operation of the corresponding compressor (13a, 13b) in response to a signal received from the other electronic unit (14a, 14b). Thereby the control system (12) is adapted to control the operation of the two or more compressors (13a, 13b) in a mutually dependent manner. When one compressor (13a, 13b) of a multi-compressor refrigeration system (17) stops operating, the remaining compressor(s) (13a, 13b) will build up a pressure difference between the pressure side and the suction side. It may be difficult for the stopped compressor (13a, 13b) to start up against this pressure difference when restart is required. Such problems are avoided in the present invention. The invention further relates to a refrigeration system (17) comprising the control system (12), and to a method of controlling a refrigeration system.

### CROSS REFERENCE TO RELATED APPLICATIONS

This application is entitled to the benefit of and incorporates by reference essential subject matter disclosed in International Patent Application No. PCT/DK2006/000465 filed on Aug. 30, 2006 and Danish Patent Application No. PA 2005 01244 filed Sep. 6, 2005.

### FIELD OF THE INVENTION

The present invention relates to a control system and a method for controlling a refrigeration system comprising two or more compressors. The present invention further relates to a refrigeration system comprising such a control system. More particularly, the present invention relates to so-called ‘twin compressors’ where two compressors are connected in the same refrigeration system.

### BACKGROUND OF THE INVENTION

When two or more compressors are connected in the same refrigeration system problems may arise when, for some reason, one of the compressors is stopped and the remaining compressors keep running. In this case the running compressors will build up a pressure difference between the pressure side and the suction side of the compressors, and this pressure difference may make it difficult for the stopped compressor to restart when required. Similar problems may arise in a refrigeration system comprising two compressors when both compressors have been stopped and only one of the compressors is restarted. In this case it may also be difficult for the remaining compressor to restart at a later time for similar reasons as the ones described above.

WO 01/069147 discloses a refrigeration system having a number of compressors, each having a control and safety module. Each of the control and safety modules communicates with a controller over a single power and communications line. The compressors are controlled by the control and safety modules in such a manner that a compressor is deactivated if it is sensed that an operating parameter falls outside a defined safety range. However, the compressors are controlled individually, and the problems described above are therefore not solved by the refrigeration system disclosed in WO 01/069147.

### SUMMARY OF THE INVENTION

It is, thus, an object of the present invention to provide a control system for controlling a refrigeration system comprising two or more compressors, which is capable of preventing, or at least considerably reducing, the problems described above.

It is a further object of the present invention to provide a method of controlling a refrigeration system comprising two or more compressors, in such a manner that the problems described above are prevented, or at least considerably reduced.

According to a first aspect of the invention the above and other objects are fulfilled by providing a control system for controlling a refrigeration system comprising two or more compressors, the control system comprising:
a first electronic unit connected to a first compressor,
a second electronic unit connected to a second compressor,
   wherein the first and second electronic units are adapted to communicate appropriate signals to the other electronic unit when the corresponding compressor starts or stops operation, and wherein the first and second electronic units are adapted to control the operation of the corresponding compressor in response to a signal received from the other electronic unit, the control system thereby being adapted to control the operation of the two or more compressors of the refrigeration system in a mutually dependent manner.

The first and second electronic units are connected to the first and second compressors, respectively. This should be understood in such a way that the electronic units are able to communicate with their respective compressor, i.e. they are at least able to detect when the corresponding compressor starts or stops, and to communicate control signals to the corresponding compressor, thereby controlling start/stop of the corresponding compressor. The connection between a control unit and the corresponding compressor may, e.g., comprise one or more electrical connections, such as an ordinary wire connection. Alternatively or additionally, the connection may be or comprise any other suitable kind of connection means, such as an infrared connection, a radio frequency (RF) connection and/or any other suitable connection.

The first and second electronic units may be positioned at or near the first and second compressors, respectively. Alternatively, one or both may be positioned remotely from their corresponding compressor.

The first and second electronic units are adapted to communicate appropriate signals to the other electronic unit. Thus, a direct or indirect communication channel is present between the electronic units. This communication channel may, e.g., comprise one or more of the connections mentioned above. Alternatively or additionally, the communication channel may be or comprise a data communication network, such as a local area network (LAN), a wireless local area network (WLAN), etc.

In the present context the term ‘appropriate signals’ should be interpreted as signals which a suitable for being communicated via the chosen communication channel. Thus, in case the communication channel is an ordinary wire, the signals should be electrical signals, etc. Furthermore, the signals should be of such a nature that, upon receipt, the receiving electronic unit will be able to recognise whether the compressor corresponding to the sending electronic unit has started or stopped. Thus, a ‘start’ signal should be distinguishable from a ‘stop’ signal.

Thus, in case one of the compressors for some reason stops, e.g. because it falls out or because it is switched off due to a decrease in need for refrigeration capacity, the corresponding electronic unit detects this and generates and sends a signal to the other electronic unit. When the other electronic unit receives this signal, it ‘knows’ that the compressor corresponding to the sending electronic unit has stopped, and it can control the other compressor in accordance with this ‘knowledge’, i.e. in response to the received signal. Thereby the operation of the compressors is controlled in a mutually dependent manner. The other compressor may accordingly be stopped, thereby avoiding problems relating to pressure difference as described above. This is very advantageous.

Similarly, if one of the compressors is started, the corresponding electronic unit will detect this and generate and send an appropriate signal to the other electronic unit. The other electronic unit will then be able to control the other compressor accordingly, i.e. typically start the other compressor shortly thereafter, thereby avoiding the problems described above.

In one embodiment the first and second electronic units may be powered by at least one battery. The battery may further be used for powering the compressors. In this case the mutually dependent manner of controlling the operation of the compressors may also be used for avoiding overload of the battery due to two or more compressors starting simultaneously. Thus, in case one compressor starts, the corresponding electronic unit communicates this information to the other electronic units, and thereby start of any of the other compressors can be delayed until the compressor has started properly, thereby avoiding overload of the battery. This embodiment is particularly useful for movable refrigeration systems, such as refrigerators, freezers or air condition systems positioned onboard vehicles, boats, etc.

In one embodiment the first electronic unit and the second electronic unit may be the same. In this case one common electronic unit controls the first compressor as well as the second compressor, and there is accordingly no need for communicating signals between the first electronic unit and the second electronic unit. It is, however, important that the common electronic unit is capable of controlling the compressors in a mutually dependent manner as described above. The common electronic unit may be positioned at or near one of the compressors. Alternatively, it may be positioned remotely from both the compressors.

Alternatively, the first and second electronic units may be separate units, each connected to and controlling the operation of a compressor. In this case the compressors and electronic units may preferably be standard components, such as the battery driven PLBD compressors and corresponding standard electronic units. This is very advantageous because the need for designing special parts for the refrigeration system may thereby be avoided.

The control system may advantageously form part of a refrigeration system, further comprising two or more compressors and at least one evaporator. The refrigeration system may further comprise at least one battery for powering at least the two or more compressors and the first and second electronic units. This has been described above.

According to a second aspect of the invention the above and other objects are fulfilled by providing a method of controlling a refrigeration system comprising two or more compressors, each being provided with a corresponding electronic unit, the method comprising the steps of:
a first electronic unit sensing that operation of the corresponding compressor has stopped,
the first electronic unit generating and communicating a signal to at least a second electronic unit, said signal indicating that operation of the first compressor has stopped, and
the second electronic unit stopping operation of the corresponding compressor in response to the signal received from the first electronic unit.

It should be noted that a skilled person would readily recognise that any feature described in relation to the first aspect of the invention may also be combined with the second aspect of the invention, and vice versa.

As described above, the fact that the second electronic unit stops the operation of the corresponding compressor in response to the signal received from the first electronic unit provides the possibility of avoiding the problems relating to pressure difference described above, because the compressors are thereby controlled in a mutually dependent manner.

The electronic units are capable of detecting that their corresponding compressor starts or stops. This may be done in many different ways, but it should be noted that the electronic units in any case should be able to communicate with their corresponding compressor, e.g. in a manner described above.

The method may further comprise the step of the first and second electronic units restarting the operation of the corresponding compressors a predetermined time interval after the operation of the second compressor has been stopped. The reason why a predetermined time interval is allowed to lapse before the compressors are restarted is that the system is thereby allowed to equalise a possible pressure difference before it is attempted to restart the compressors. Consequently, the predetermined time interval should be sufficiently long to allow such a pressure equalisation. Typically, the predetermined time interval is a fixed time interval, e.g. approximately 2 minutes. If the pressure is not equalised after 2 minutes, and the compressors are consequently not able to restart, the system may allow another 2 minutes to lapse before retrying.

The first and second compressors may be restarted sequentially with a specific time interval in between. As described above, this is particularly advantageous when the compressors are powered by a battery. By starting the compressors sequentially it is avoided that they are started simultaneously, and thereby overload of the battery can be avoided.

In one embodiment the step of restarting the operation of the compressors may comprise the steps of:
the first/second electronic unit restarting the operation of the first/second compressor,
the first/second electronic unit generating and communicating a signal to the second/first electronic unit, said signal indicating that the operation of the first/second compressor has been restarted, and
the second/first electronic unit restarting the operation of the second/first compressor in response to the signal received from the first/second electronic unit.

### BRIEF DESCRIPTION OF THE DRAWINGS

The invention will now be described in further details with reference to the accompanying drawings in which:

FIG. 1 is a flow chart illustrating a method of stopping two compressors according to an embodiment of the invention,

FIG. 2 is a flow chart illustrating a method of sequentially starting two compressors according to an embodiment of the invention,

FIG. 3 is a schematic diagram illustrating a control system according to an embodiment of the invention, and

FIG. 4 is a schematic diagram illustrating a refrigeration system according to an embodiment of the invention.

### DETAILED DESCRIPTION OF THE PREFERRED EMBODIMENTS

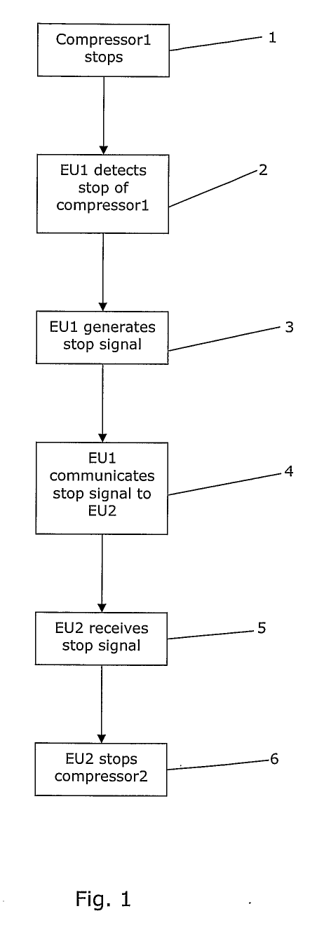

FIG. 1 is a flowchart illustrating a method of stopping two compressors. At step 1 compressors stops for some reason. This may be because the compressor falls out, e.g. due to a fault, or it may be because the compressor is stopped in response to a decreased need for refrigeration capacity. At step 2 the electronic unit corresponding to compressors, EU1, detects that compressors has stopped. Accordingly, EU1 generates a stop signal at step 3 and communicates this stop signal to the other electronic unit, EU2, at step 4. At step 5 EU2 receives the stop signal, and at step 6 EU2 stops the corresponding compressor, compressors, in response to the received stop signal.

As mentioned above, the method illustrated in the flowchart of FIG. 1 ensures that when one of the compressors stops, the other compressor will also be stopped. Thereby the compressors are operated in a mutually dependent manner, and the problems relating to pressure difference mentioned above can accordingly be avoided.

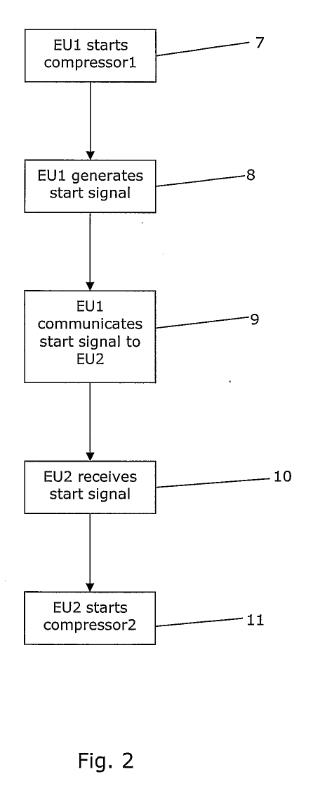

FIG. 2 is a flowchart illustrating a method of sequentially starting two compressors. At step 7 one electronic unit, EU1, starts its corresponding compressor, compressors. At step 8 EU1 generates a start signal indicating that it has started compressors, and at step 9 it communicates the generated start signal to the other electronic unit, EU2. At step 10 EU2 receives the start signal, and at step 11 EU2 starts its corresponding compressor, compressors, in response to the received start signal.

As described above, the starting method illustrated in the flowchart of FIG. 2 ensures that problems relating to pressure difference as mentioned above can be avoided.

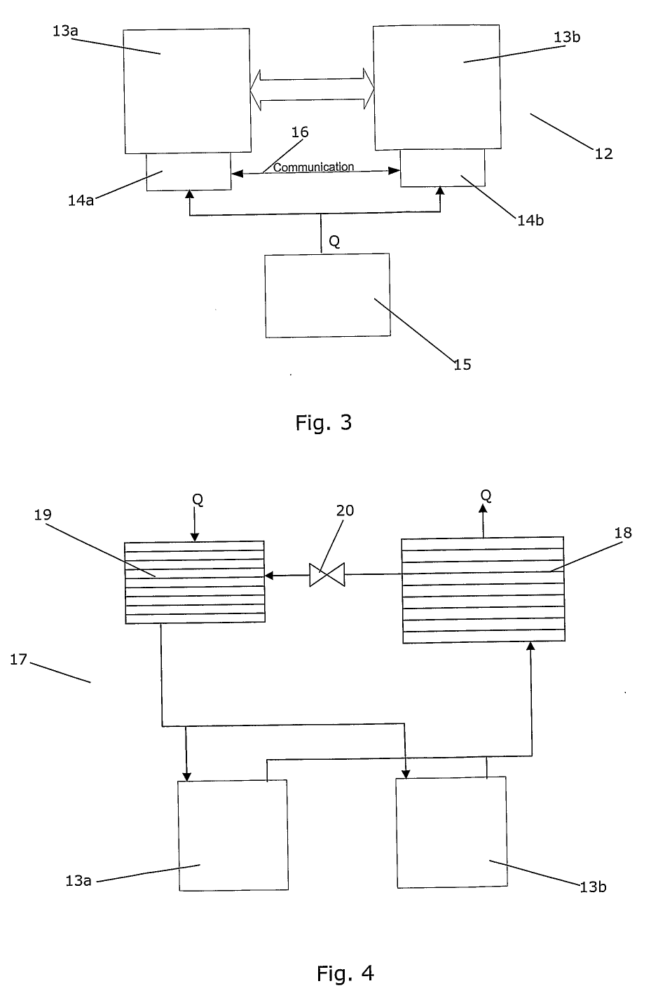

FIG. 3 is a schematic diagram illustrating a control system 12 according to an embodiment of the invention. The control system 12 is adapted to control the operation of a refrigeration system comprising at least two compressors. In FIG. 3 two compressors 13a, 13b are shown for illustration. It should be noted that the system may comprise further compressors. The arrow shown between the compressors 13a, 13b indicates that the compressors 13a, 13b are connected in the same refrigeration system.

To each compressor 13a, 13b there is attached an electronic unit 14a, 14b. Each electronic unit 14a, 14b is connected to a battery 15 which thereby supplies power to the electronics units 14a, 14b, and preferably also to the compressors 13a, 13b.

A communication channel 16 is established between the electronic units 14a, 14b. Thereby the electronic units 14a, 14b can communicate appropriate information to each other. Thus, as described above, in case the first compressor 13a stops, the corresponding electronic unit 14a can communicate this to the other electronic unit 14b which in return can stop the operation of the second compressor 13b, or vice versa. Similarly, an appropriate signal may be communicated in case one of the electronic units 14a, 14b starts the corresponding compressor 13a, 13b. Thereby the communication channel 16 makes it possible to operate the compressors 13a, 13b in a mutually dependent manner.

The compressors 13a, 13b and electronic units 14a, 14b illustrated in FIG. 3 are preferably standard units, such as standard PLBD compressors with associated standard electronic units. This is advantageous since the need for the development of special components is thereby avoided. However, it should be noted that the two electronic units 14a, 14b may alternatively be replaced by a single electronic unit connected to and controlling the operation of both compressors 13a, 13b.

FIG. 4 is a schematic diagram illustrating a refrigeration system 17 according to an embodiment of the invention. The refrigeration system 17 comprises two compressors 13a, 13b which are controlled by a control system as described above in connection with FIG. 3. Each of the compressors 13a, 13b supply refrigerant to a condenser 18 which is in turn connected to an evaporator 19 via a valve 20. From the evaporator 19 the refrigerant is returned to the compressors 13a, 13b. At the condenser 18 heat is liberated from the refrigerant. This is illustrated by the ‘Q’ and an arrow pointing outwards. At the evaporator 19, on the other hand, heat is absorbed by the refrigerant from the surrounding air. This is illustrated by the ‘Q’ and an arrow pointing inwards. This is the normal operation of a refrigeration system.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A control system for controlling a refrigeration system comprising two or more compressors, the control system comprising:
a first electronic unit connected to a first compressor,
a second electronic unit connected to a second compressor
wherein the first and second electronic units are adapted to communicate appropriate signals to the other electronic unit when the corresponding compressor starts or stops operation, and wherein the first and second electronic units are adapted to control start/stop of the corresponding compressor in response to a signal received from the other electronic unit, the control system thereby being adapted to control start and sop of the two or more compressors of the refrigeration system in a mutually dependent manner.

2. The control system according to claim 1, wherein the first and second electronic units are powered by at least one battery.

3. The control system according to claim 1, wherein the first electronic unit and the second electronic unit are the same.

4. A refrigeration system comprising two or more compressors, at least one evaporator, and a control system according to claim 1.

5. The refrigeration system according to claim 4, further comprising at least one battery for powering at least the two or more compressors and the first and second electronic units.

6. A method of controlling a refrigeration system comprising two or more compressors, each being provided with a corresponding electronic unit, the method comprising the steps of:
a first electronic unit sensing that operation of the corresponding compressor has stopped,
the first electronic unit generating and communicating a signal to at least a second electronic unit, said signal indicating that operation of the first compressor has stopped, and
the second electronic unit stopping operation of the corresponding compressor in response to the signal received from the first electronic unit.

7. The method according to claim 6, further comprising the step of the first and second electronic units restarting the operation of the corresponding compressors a predetermined time interval after the operation of the second compressor has been stopped.

8. The method according to claim 7, wherein the first and second compressors are restarted sequentially with a specific time interval in between.

9. The method according to claim 8, wherein the step of restarting the operation of the compressors comprises the steps of:
the first/second electronic unit restarting the operation of the first/second compressor,
the first/second electronic unit generating and communicating
a signal to the second/first electronic unit, said signal indicating that the operation of the first/second compressor has been restarted, and
the second/first electronic unit restarting the operation of the second/first compressor in response to the signal received from the first/second electronic unit.
